(19) United States
(12) Patent Application Publication
(10) Pub. No.: US 2008/0089536 A1
(43) Pub. Date: Apr. 17, 2008

(54) Microphone Microchip Device with Differential Mode Noise Suppression

(75) Inventor: Olafur Josefsson, North Reading, MA (US)

Correspondence Address: BROMBERG & SUNSTEIN LLP, 125 SUMMER STREET, BOSTON, MA, 02110-1618, US

(73) Assignee: ANALOG DEVICES, INC., Norwood, MA (US)

(21) Appl. No.: 11/870,468

(22) Filed: Oct. 11, 2007

Related U.S. Application Data
(60) Provisional application No. 60/828,996, filed on Oct. 11, 2006.

(51) Int. Cl. H04R 3/06; H04B 1/10

(52) U.S. Cl. 381/113; 375/346

(57) ABSTRACT

A system for processing a sound input to a MEMS microphone in a voice communication device, such as a cellular telephone. The system includes the microphone and a processing microchip. The processing microchip includes a differential receiver that receives the signal output of the microphone on one input and a voltage that biases the microphone on the other input. The output of the differential receiver represents the audio signal from the microphone, while noise signals induced on connections between the microphone and microchip are received equally on the differential receiver inputs, thereby cancelling. Further, the processing microchip also includes a bias voltage generator circuit for supplying a bias voltage to the microphone. Noise that is coupled onto or is inherent in the bias voltage generator circuit or couples onto the signal path from the bias voltage generator to the microphone will traverse substantially symmetrical paths to the differential receiver. This noise will also cancel at the receiver. Thus, the system provides a high fidelity rendering of sound input to the microphone while mitigating interference from noise.

This application claims priority from U.S. provisional patent application, Ser. No. 60/828,996, filed Oct. 11, 2006, entitled “Microphone Circuit Chip with Differential Mode Noise Suppression,” attorney docket no. 2550/B33, which is incorporated herein by reference.

### TECHNICAL FIELD

The invention generally relates to microphones for voice communication devices and, more particularly, the invention relates to noise suppression in microphone circuitry microchips for cellular telephones.

### BACKGROUND OF THE INVENTION

Cellular telephones typically have a microphone and associated circuitry to convert sound waves into an electronic signal for transmission to another telephone. The circuitry modulates a high frequency radio-frequency (“RF”) carrier signal (e.g., 1 to 2 GHz) with the microphone signal and transmits this modulated carrier signal via an antenna on the telephone. This modulated RF carrier signal is received by a base station (“a cell”) and forwarded to another telephone.

A block diagram for a conventional cellular telephone 10 is shown in FIG. 1. The telephone 10 has a body 12 with a microphone 14 for receiving sound input from a human voice, a loudspeaker 16 for generating sound output and an antenna 18 for transmitting and receiving modulated RF signals. The telephone includes receiver circuits for converting received RF signals to audio signals to drive the loudspeaker 16. Illustratively, the receiver electronics may include demodulating 20, signal processing 22, de-interleaving 24, speech decoding 26 and digital-to-analog conversion 28 components. The telephone 10 further includes transmitter circuits for converting sound input received by the microphone 14 to RF signals for transmission. Illustratively, the transmitter electronics may include buffering 38 analog-to-digital conversion 36, signal processing 34, interleaving 32, and modulating 30 components.

A cellular telephone typically comprises many physical components packed into a small physical space. Consequently, electromagnetic energy may escape from some of these components and couple into other cellular telephone components, thereby causing noise interference. (Of particular concern is the energy emitted from the telephone's antenna 18.) Pickup of noise signals at audio frequencies is particularly troublesome because these noise signals can interfere with the operation of the loudspeaker 16 or microphone 14. This audio interference can adversely affect the operation of the cellular telephone. A particular problem is the audio interference signal that may be induced by time division interleaving of transmitter signals with receiver signals in the telephone. Such interleaving can be performed by the receiver de-interleave circuit 24 and in the transmitter interleave circuit 32. For example, transmitter and receiver RF carrier signal interleaving is performed at a 217 Hz rate in a Time Division Multiple Access (“TDMA”) transmitter/receiver of a Global System for Mobile Communications (“GSM”) mobile telephone. Non-linear circuit elements in a cellular telephone can convert the turn-on and turn-off of the telephone's RF carrier for transmission at the 217 Hz rate into an audio interference signal at 217 Hz. Audio signal noise at this frequency resembles the sound of a bumblebee and is thus known as “bumblebee noise.” Such bumblebee noise can impact the ability of a cellular telephone to function as a voice communication device.

### SUMMARY OF THE INVENTION

In an embodiment of the invention, a microphone system for a voice communication device is provided. The system includes a micro-electromechanical system (“MEMS”) microphone and a processing microchip. The MEMS microphone includes a microphone output signal port; a microphone bias voltage input port, and a variable capacitance sound transducer. The sound transducer has a first end electrically connected to the microphone output signal port and a second end electrically connected to the microphone bias voltage input port. The processing microchip includes a differential receiver that processes the difference of signals at its two inputs. The microchip also includes a bias voltage circuit for generating a bias voltage output for the microphone. A first connection electrically connects the microphone output signal port to one input of the differential receiver. A second connection electrically connects the second input of the receiver to the microphone bias voltage input port and to the microphone bias voltage output port. The second connection is formed such that the differential receiver processes the difference between the microphone signal and a substantially fixed voltage, and such that noise associated with the bias voltage circuit and noise coupled into the first connection cancels at the differential receiver. RF carrier signal induced noise and bias voltage circuit noise are rejected by the circuit because these signals are injected equally into both inputs of the differential receiver. Thus, the differential receiver passes the single-ended sound signal from the microphone substantially unaffected by this noise. The fidelity of the microphone signal output by the microchip is thereby improved.

In a specific embodiment of the invention, the second connection includes a second capacitance which is approximately equal to the capacitance of the sound transducer. This second capacitance may be included in the MEMS microphone or in the processing microchip.

In an embodiment of the invention, a microchip for processing a microphone signal from a MEMS microphone, in a voice communication device, is provided. The MEMS microphone has a variable capacitance transducer for converting sound to an electrical signal. The microchip includes a differential receiver for receiving the microphone signal. One input of the differential receiver is connected to a microchip receiving port for the microphone signal. The other differential receiver input is connected through a capacitance to a port on the microchip, which supplies a bias voltage to the microphone. When the second capacitance is set approximately equal to the capacitance of the microphone transducer, noise induced at the receiving port and at the bias voltage output port is substantially cancelled by the differential receiver. Modulated RF carrier signal induced noise and bias voltage circuit noise are rejected by the circuit because these signals are injected equally into both inputs of the differential receiver. Thus, the differential receiver passes the single-ended microphone signal substantially unaffected by this noise. The fidelity of the microphone signal output by the microchip is thereby improved.

### BRIEF DESCRIPTION OF THE DRAWINGS

The foregoing features of the invention will be more readily understood by reference to the following detailed description taken with the accompanying drawings:

FIG. 1 is a block diagram of a conventional cellular telephone;

FIG. 2 shows a packaged microphone and processing microchip that may be used in the telephone of FIG. 1, in embodiments of the present invention;

FIG. 3 shows a cross-sectional view of the microphone and processing microchip of FIG. 2;

FIG. 4 is a circuit diagram of the microphone and processing microchip shown in FIGS. 2 and 3, according to an embodiment of the invention; and

FIGS. 5A and 5B are circuit diagrams of alternative embodiments of the microphone and processing microchip.

### DETAILED DESCRIPTION OF EMBODIMENTS OF THE INVENTION

In accordance with embodiments of the invention, a microchip processes a microphone signal from a MEMS microphone in a voice communication device, such as a cellular telephone. The voice communication device employs a modulated RF carrier for signal transmission and reception. RF carrier signal noise and other non microphone related noise sources, and noise from bias voltages applied to the microphone can interfere with reception of the microphone signal at the microchip. Such interference can couple into the microchip via connections between the microphone and microchip. Interference is mitigated by employing a differential receiver to process the microphone signal. The microphone signal is received by the differential receiver as a single-ended signal. The other input of the differential receiver has another input that is arranged to have the same coupled noise and bias voltage related noise as the microphone signal input to the receiver. Thus, these two noise sources present common mode noise which is cancelled by the differential receiver. Interference with sound signals from the microphone is thereby reduced.

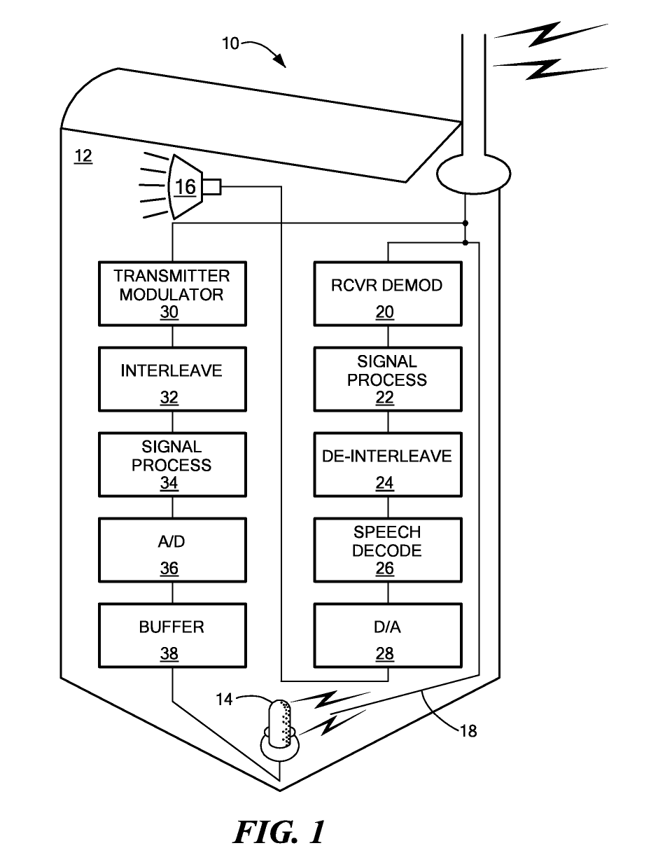

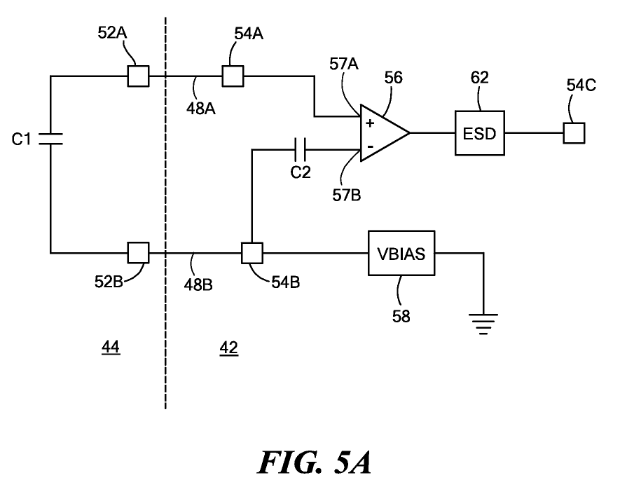

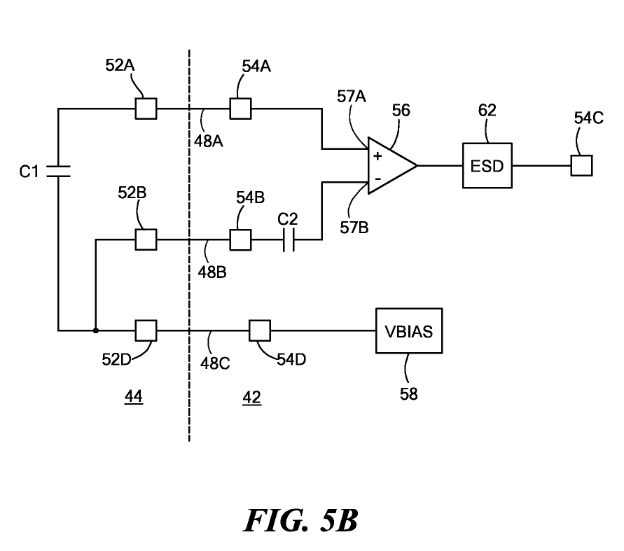

A cellular telephone similar to the cellular telephone 10 shown schematically in FIG. 1 may be used to implement illustrative embodiments of the invention. The microphone 14 acts as a transducer that converts sound into electrical signals. In illustrative embodiments, the microphone is a MEMS microphone having a capacitance that varies as a function of incident sound waves. This capacitance is often referred to as the “capacitance of the microphone” and identified in FIGS. 4, 5A and 5B (discussed below) by reference indicator “C1.”

Associated microphone processing circuitry processes sound signals from the microphone 14 for transmission through the antenna 18. For example, among other things, the microphone circuitry may amplify the microphone signal, provide a bias voltage to the microphone, and/or suppress potentially destructive electrostatic discharges. This circuitry may implement one or more sound signal processing functions such as, buffering 38, analog-to-digital conversion 36, signal processing 34, interleaving 32, and modulating 30, as shown in the block diagram of FIG. 1. In some embodiments, the microphone and microphone processing circuitry are integrated on a single chip. In other embodiments, however, the microphone and microphone processing circuitry are implemented on separate chips that are both contained within a single package. In illustrative embodiments, the microphone microchip circuitry may be implemented as an application specific integrated circuit (“ASIC”).

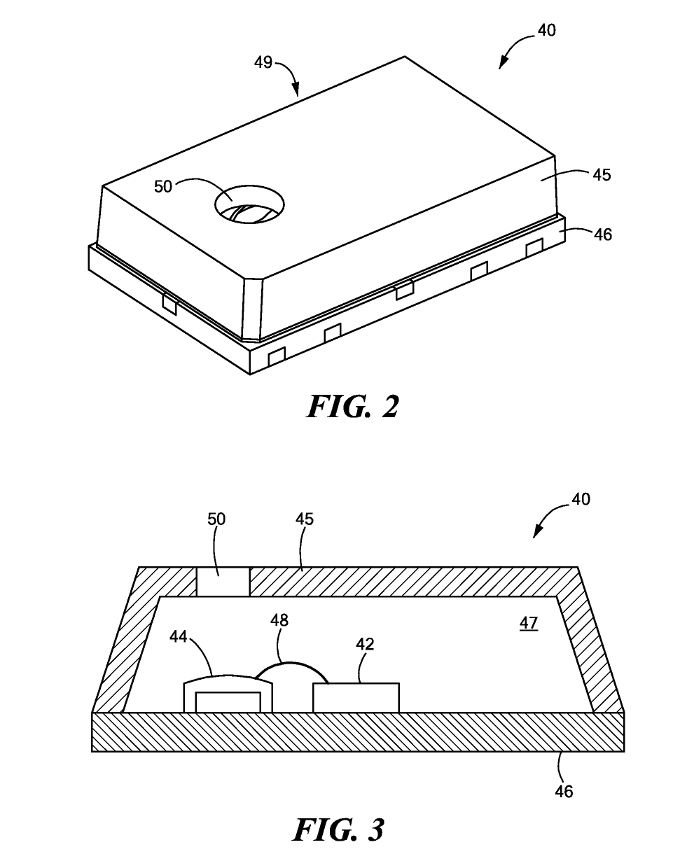

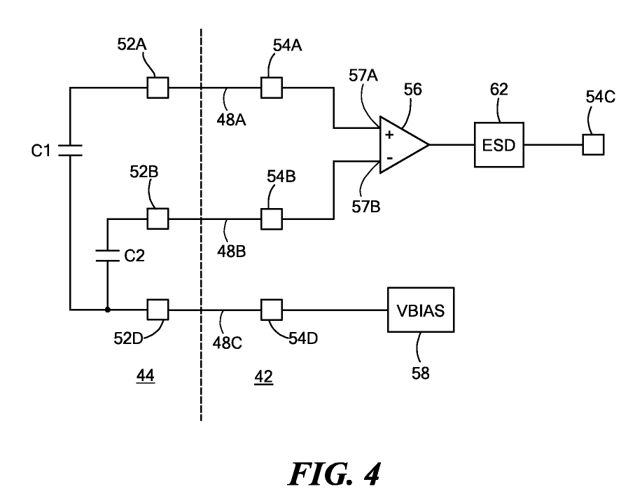

FIG. 2 schematically shows such a microphone system 40 implemented within a single package, while FIG. 3 schematically shows a cross-sectional view of the same microphone system 40. Specifically, the microphone system 40 shown generally in FIG. 2 (and in cross section in FIG. 3) has a package 49 with a base 46 that, together with a corresponding lid 45, forms an interior cavity 47 containing a MEMS microphone 44 and a microphone microchip 42. The lid 45 in this embodiment is a cavity-type lid, which has four walls extending generally orthogonally from a top, interior face. The lid 45 secures to the top face of the substantially flat package base 46 to form the interior cavity 47. The lid 45 also has an audio input port 50 that allows sound to enter the cavity 47. In alternative embodiments, however, the audio input port 50 may be at another location, such as through the package base 46, or through one of the side walls of the lid 45.

Acoustic signals entering the interior cavity 47 interact with the MEMS microphone 44 to produce an electrical signal which, after being processed by the microphone microchip 42 and additional (exterior) components (e.g., a transceiver), is transmitted via the antenna 18 to a receiving device (e.g., a cell tower). Although not shown, the bottom face of the package base 46 has a number of contacts for electrically (and physically, in many anticipated uses) connecting the microphone with a substrate, such as a printed circuit board or other electrical interconnect apparatus. In illustrative embodiments, the package base 46 is a premolded, lead frame-type package (also referred to as a “premolded package”). Other types of packages may be used, however, such as ceramic packages. Wire bonds 48 may connect the MEMS microphone 44 with the microphone microchip 42.

FIG. 4 is a circuit diagram of the microphone 44 and microphone microchip 42, shown in FIGS. 2 and 3, in an embodiment of the invention. The circuit has a variable capacitor C1 representing the variable capacitance sound transducer, C1, of the MEMS microphone 44, and three bond pads 52A, 52B, 52D on the MEMS microphone 44 for connecting with corresponding bond pads 54A, 54B, 54D on the microphone microchip 42. The connections are made via wire bonds 48A, 48B, 48C. In other embodiments of the invention, where, for example, the microphone and microphone microchip circuits are implemented on a single chip, other forms of interconnection, as are known in the art, may be employed.

The microphone microchip 42 has an input pad 54A for receiving a microphone signal from the MEMS microphone 44. The input pad 54A connects to one input 57A of a differential amplifier/output buffer 56 that buffers and may level shift the microphone signal. (For example, the differential amplifier 56 may shift the microphone signal from the microphone 44 anywhere from 0.6 volts to 1.2 volts DC.) The microphone microchip 42 also has a bias voltage generator 58 for providing a bias voltage for the variable capacitor C1 of the MEMS microphone 44. For example, this bias voltage may be about 4 volts. The bias voltage generator 58 communicates the bias voltage to the MEMS microphone 44 through a bias voltage output pad 54D connected to a bias voltage input pad 52D on the microphone 44. The bias voltage input pad 52D is connected to the second input 57B of the differential amplifier/output buffer 56 though a capacitance C2. The capacitance C2 is situated in the MEMS microphone 44. The capacitance C2 is chosen to match as closely as possible the mean capacitance of variable capacitor C1 of the MEMS microphone 44 sound transducer. (Capacitance C2 may be implemented in any convenient fashion known in the art: C2 need not be implemented in the same manner as the variable capacitance sound transducer C1.) The impedances of the signal paths for modulated RF carrier noise induced in the microphone or on the wire bonds 48A, 48B to the two inputs 57A, 57B of the differential amplifier are, therefore, approximately equal. Thus, such noise will cancel at the differential amplifier 56. Likewise, any noise that is coupled onto or is inherent in the bias voltage generator circuit 58 or couples onto the signal path from the bias voltage generator 58 output to pad 52D will traverse substantially symmetrical paths via capacitance C1 and capacitance C2 to the two inputs 57A, 57B of the differential amplifier 56, and thus, will cancel at the differential amplifier 56. The microphone signal will appear as a single-ended signal to the differential amplifier/output buffer, i.e., the amplifier 56 will receive the microphone signal at one input 57A and a substantially fixed voltage at the other input 57B. The buffered microphone signal will be fed from the differential amplifier output through the optional ESD suppression element 62 and will appear at the microphone signal output pad 54C of the microphone microchip 42. Embodiments of the invention, thus, advantageously reduce noise interference in the microphone microchip, enhancing the fidelity of the microphone signal. Further, because the differential amplifier will substantially cancel noise from the bias voltage generator, the design of the bias voltage generator may be simplified.

The amplifier/output buffer 56 in the microphone microchip 42 may be a programmable amplifier/output buffer. Further, electrostatic discharge suppression circuitry (referred to as “ESD”) for suppressing electrostatic discharges may be employed. ESD circuitry 62 typically includes a diode and may include other non-linear circuit elements.

FIGS. 5A and 5B are circuit diagrams for alternative embodiments of the invention. These alternative embodiments place capacitance C2 in the microphone microchip 42. These implementations may be less costly than placing capacitance C2 in the MEMS microphone 44, as in the embodiment of FIG. 4. In various embodiments of the invention, the value of capacitance C2 may be set according to the expected magnitude and frequency of the noise sources.

The circuit of FIG. 5A has two connections from the microphone microchip 42 to the MEMS microphone 44. Differential amplifier 56 input 57B is connected through capacitor C2 to output pad 54B, which connects to the output of the bias voltage generator circuit 58. Wire bond 48B connects this output pad to the bias voltage input pad 52B of the microphone 44, which connects to one end of sound transducer microphone capacitance C1. The other input 57A of differential amplifier 56 connects to the microphone transducer, as in FIG. 4.

In the embodiment of FIG. 5A, any noise that is coupled onto or is inherent in the bias voltage generator circuit 58 or couples onto the signal path from the bias voltage generator 58 output to pad 52B will traverse substantially symmetrical paths via capacitance C1 and capacitance C2 to the two inputs 57A, 57B of the differential amplifier 56. Thus, this noise will be rejected by the differential amplifier 56 as common mode signals. For this rejection, the impedances of capacitance C1 and capacitance C2 (at the frequency of the noise coupling) may be closely matched.

In other specific embodiments of the invention shown in FIG. 5A, the value and impedance of capacitance C2 may differ from that of capacitance C1. This may be advantageous, for example, when noise couples substantially equally onto paths 54A to 52A as onto paths 54B to 52B. In this instance, C2 serves to conduct as much of the noise present at 54B onto input node 57B as possible. This arrangement ensures that the coupled noise gets presented substantially equally to both inputs of differential amplifier 56 and this common node noise will therefore be cancelled.

The circuit of FIG. 5B is the same as the circuit of FIG. 5A, except that three connections from the microphone microchip 42 to the MEMS microphone 44 are provided. The connection from the input 57B of the differential amplifier 56 is brought out to an output pad 54B through capacitor C2. Output pad 54B is separate from the output pad 54D for the bias voltage generator output 58. Each of these output pads is connected via a wire bond 48B, 48C to a corresponding pad 52B, 52D in the MEMS microphone 44. (In other embodiments of the invention, connections other than wire bonds may be used.) This embodiment may provide more symmetry in the signal paths to the inputs 57A, 57B of the differential amplifier 56 than in the circuit of FIG. 5A. Thus, overall noise rejection may be improved.

In the embodiment of FIG. 5B, any noise that is coupled onto or is inherent in the bias voltage generator circuit 58 or couples onto the signal path from the bias voltage generator 58 output to pad 52D will traverse substantially symmetrical paths via capacitance C1 and capacitance C2 to the two inputs 57A, 57B of the differential amplifier 56. Thus, this noise will be rejected by the differential amplifier 56 as common mode signals. For this rejection, the impedances of capacitance C1 and capacitance C2 (at the frequency of the noise coupling) may be closely matched.

In other specific embodiments of the invention shown in FIG. 5B, the value and impedance of capacitance C2 may differ from that of capacitance C1. This arrangement may be advantageous, for example, when noise couples substantially equally onto paths 54A to 52A as onto paths 54B to 52B. In this instance, C2 serves to conduct as much of the noise present at 54B onto input node 57B as possible. This arrangement ensures that the coupled noise gets presented substantially equally to both inputs of differential amplifier 56 and this common node noise will therefore be cancelled.

Embodiments of the present invention, therefore, can attenuate common mode noise (i.e., noise that couples onto both lines input to the differential amplifier, such as an RF interference signal, clock noise, etc.) In addition, as noted above, various embodiments attenuate the noise generated by or coupled onto the bias voltage generator 58 or onto the voltage supply lines because such noise also will be rejected as common mode noise by the differential amplifier 56. Accordingly, the bias voltage generator 58 itself can have a simpler, less expensive, and more power efficient design that does not require adjustments, specialized components or configurations due to its inherent noise generation.

Although the above discussion discloses various exemplary embodiments of the invention, it should be apparent that those skilled in the art can make various modifications that will achieve some of the advantages of the invention without departing from the true scope of the invention.

What is claimed is:

1. A microphone system for a voice communication device, comprising:
a MEMS microphone, including:
a microphone output signal port;
a microphone bias voltage input port;
a capacitive sound transducer with a first end and second end, the first end of the transducer electrically connected to the microphone signal port and the second end of the transducer electrically connected to the microphone bias voltage input port, the transducer characterized by a first capacitance; and
a processing microchip, including:
a differential receiver having a first input and a second input, the differential receiver processing a difference of signals received at the first input and at the second input, the first input electrically connected to a microphone signal receiving port; and
a bias voltage circuit for generating a bias voltage output for the microphone, the bias voltage output electrically connected to a microphone bias voltage output port;
a first connection electrically connecting the microphone signal receiving port to the microphone output signal port; and
a second connection electrically connecting the microphone bias voltage input port to the second input of the differential receiver and to the microphone bias voltage output port, the second connection formed such that the differential receiver processes the difference between the microphone signal and a substantially fixed voltage, and such that noise associated with the bias voltage circuit and noise coupled into the first connection cancels at the differential receiver.

2. A microphone system according to claim 1 wherein the differential receiver comprises a differential amplifier.

3. A microphone system according to claim 1, wherein the second input of the differential receiver is electrically connected to the microphone bias voltage input port through a second capacitance.

4. A microphone system according to claim 3, wherein the second capacitance is substantially equal to the first capacitance.

5. A microphone system according to claim 4, wherein the MEMS microphone includes the second capacitance.

6. A microphone system according to claim 4, wherein the processing microchip includes the second capacitance.

7. A microphone system according to claim 5, wherein the first connection includes a wire bond and the second connection includes a wire bond.

8. A microphone system according to claim 6, wherein the first connection includes a wire bond and the second connection includes a wire bond.

9. A microchip for processing a microphone signal from a MEMS microphone in a voice communication device, the MEMS microphone characterized by a first capacitance, the microchip comprising:
a receiving port for receiving the microphone signal from the microphone;
a differential receiver having a first input and a second input, the differential receiver processing the difference of signals received at the first input and at the second input, the first input electrically connected to the receiving port; and
a bias voltage circuit for delivering a bias voltage for the microphone to a bias voltage output port;
wherein the bias voltage output port is electrically connected to the second input of the differential receiver through a second capacitance such the differential receiver processes the difference between the microphone signal and a substantially fixed voltage and when the second capacitance is approximately equal to the first capacitance, noise induced at the receiving port and at the bias voltage output port is substantially cancelled at the differential receiver.

10. A microchip according to claim 9, wherein the differential receiver comprises a differential amplifier.
